(19) United States
(12) Patent Application Publication
(10) Pub. No.: US 2012/0124845 A1
(43) Pub. Date: May 24, 2012

(54) SHARPENER FOR PENCILS AND/OR COSMETIC PENCILS

(75) Inventor: Thomas Tauschek, Ebermannstadt (DE)

(73) Assignee: Eisen GmbH, Baiersdorf (DE)

(21) Appl. No.: 13/297,885

(22) Filed: Nov. 16, 2011

(30) Foreign Application Priority Data
Nov. 16, 2010 (DE) 102010051312.1

(51) Int. Cl. B43L 23/08

(52) U.S. Cl. 30/452; 30/454

(57) ABSTRACT

A sharpener is disclosed for writing, drawing, and/or cosmetic pencils. The housing includes a collection container, a sharpening blade, and an adjacent cone-shaped sharpening channel having an insert opening. Walls of the housing include an opaque and/or translucent material. The sharpening blade comprises a sharpening channel facing a bottom portion of the housing and a top facing a shaving removal section. The sharpener also includes a viewing channel that extends from a wall of the housing through the sharpening channel to enable viewing of the bottom of the sharpening blade.

### CROSS-REFERENCE TO RELATED APPLICATIONS

This application claims priority to pending German application serial number 102010051312.1, filed Nov. 16, 2010, the entirety of which application is incorporated by reference herein.

### BACKGROUND OF THE INVENTION

1. Field of the Invention

The invention relates in general to a sharpener for writing, drawing, and/or cosmetic pencils.

2. Discussion of Related Art

Sharpeners are known for use with writing, drawing, and/or cosmetic pencils. Such sharpeners can have a housing comprising a collection container, a sharpening blade, and sharpening channel with an insert opening. The walls of the housing may comprise an opaque and/or translucent material and the sharpening blade may comprise a bottom facing the sharpening channel and a top facing a shaving removal area. Such sharpeners are known in prior art and typically have an opaque housing surrounding the sharpening blade.

The inventors have recognized that sharpeners whose housings are transparent over their entire surface are almost exclusively held during the sharpening process such that the top of the sharpener faces the observer, and thus the observer observes the top of the sharpener during the sharpening process. In this process it is disadvantageous that—particularly during the sharpening of soft-core pencils, such as cosmetic pencils, but also during the sharpening of writing, drawing, or other pencils—the top of the blade is covered by the shavings formed during the sharpening process and thus the formation of the pencil tip cannot be optimally observed. Due to the fact that the top of the sharpening blade tends to “soil” during the sharpening process it cannot be determined whether the sharpening process can be terminated. This leads to the sharpening process being performed too long and thus an unnecessary large amount of pencil material is shaved off.

Thus it would be desirable to provide an improved sharpener that overcomes the aforementioned disadvantages.

### SUMMARY OF THE INVENTION

An improved sharpener is disclosed for use with writing, drawing, and/or cosmetic pencils. The sharpener can include a housing having a collection container, a sharpening blade, and an adjacent, at least partially cone-shaped sharpening channel having an insert opening. Walls of the housing comprise at least one of an opaque and a translucent material and the sharpening blade can have a bottom facing the sharpening channel and a top facing a shaving removal area. The sharpener can further include a viewing channel extending from an opening or a clear section of at least one of said walls of the housing through the sharpening channel towards the bottom of the sharpening blade.

The viewing channel can enable a user to view an area of the bottom of the sharpening blade facing away from the insert opening. A form blade can be arranged adjacent to the sharpening blade facing away from the insert opening and the viewing channel to enable a user to view the form knife and the bottom area of the sharpening blade surrounding the form blade. The viewing channel can extends essentially perpendicular or at an angle ranging from about 45°-135° in reference to a longitudinal axis of the cone-shaped sharpening channel

The viewing channel can have lateral walls that form a closed channel structure. The viewing channel can comprise a circular, oval, rectangular, or polygonal cross-sectional contour. A cross-sectional shape of the viewing channel can be constant over its longitudinal axis. A wall-side end of the viewing channel of the sharpening channel can be closed by a transparent window section. The transparent window section can be detachably connected to the housing wall.

The sharpener can comprise at least two sharpening blades and at least two sharpening channels, each of the sharpening channels being at least partially cone-shaped, where the at least two sharpening blades each are positioned adjacent to at least one of an opening and a transparent window section of the housing wall with the viewing channel to enable a user to view respective bottom portions of the sharpening blades. The transparent window section can be detachably connected to the housing wall.

A portion of the housing can comprise the opening or the transparent window section is convex and a portion of the housing opposite the opening or the transparent window section can comprise a plane support area. A portion of the housing opposite the opening or the transparent window section can comprise a plane support area, and a remainder of the housing portions can be convex.

### BRIEF DESCRIPTION OF THE DRAWINGS

The accompanying drawings illustrate preferred embodiments of the disclosed device so far devised for the practical application of the principles thereof, and in which:

FIG. 1 is a front view of a sharpener;

FIG. 2 is a cross-section view of the sharpener of FIG. 1 taken along line II-II of FIG. 1;

FIG. 3 is a cross-section view of the sharpener of FIG. 1, without a cap, taken along line III-III of FIG. 1;

FIG. 4 is a cross-section view of the sharpener of FIG. 1, without a cap, taken along line IV-IV of FIG. 1;

FIG. 5 is a perspective view of the sharpener of FIG. 1 from the rear without a cap;

FIG. 6 is a perspective view of the sharpener of FIG. 5 with a cap; and

FIG. 7 is a schematic view of another embodiment of the sharpener.

### DESCRIPTION OF EMBODIMENTS

The invention is based on the objective to further develop a sharpener for writing, drawing, and/or cosmetic pencils such that a user can observe the bottom of the sharpening blade facing the sharpening channel during the sharpening process. Another objective of the invention is to suggest to the user the placement of the sharpener on a support area in a predetermined alignment of the sharpener such that the user, when the sharpener is placed, can see the bottom of the sharpening blade and the user is prompted to a placement of such an orientation.

Advantageously, the sharpener comprises a viewing channel extending from an opening or a translucent section (i.e., a window section) of a wall of the housing through the sharpening channel to the bottom of the blade. Due to the fact that the housing of the sharpener also includes an opaque and/or translucent material, thus the sharpening process can be exclusively observed through the viewing channel, and thus, the observer is prompted to observe the bottom of the sharpening blade during the sharpening process.

The inventors have recognized that sharpeners whose housings are transparent over their entire surface are almost exclusively held during the sharpening process such that the top of the sharpener faces the observer, and thus the observer observes the top of the sharpener during the sharpening process. In this process it is disadvantageous that—particularly during the sharpening of soft-core pencils, such as cosmetic pencils, but also during the sharpening of writing, drawing, or other pencils—the top of the blade is covered by the shavings formed during the sharpening process and thus the formation of the pencil tip cannot be optimally observed. In general it is advantageous to observe the formation of the pencil tip during the sharpening process because the status of the pencil tip indicates to the user if the sharpening process can be terminated or if the sharpening process must be continued in order to yield the desired shape of the pencil tip. Due to the fact that the top of the sharpening blade tends to “soil” during the sharpening process it cannot be determined whether the sharpening process can be terminated. This leads to the sharpening process being performed too long and thus an unnecessary large amount of pencil material is shaved off.

According to the invention, the user can only observe the bottom of the sharpening blade through the viewing channel during the sharpening process, on which any shavings collect to a considerably lesser amount, if at all, thus providing improved observation for determining whether the sharpening process must be continued or not.

In one embodiment the viewing channel enables the user to view a section of the bottom of the sharpening blade opposite the insert opening. In general, it is not necessary to enable the user to view the entire sharpening blade during the sharpening process, but rather it is can be sufficient to enable viewing of a section of the bottom of the sharpening blade opposite the insert opening and/or at least a section of the sharpening blade responsible for shaving off the core material of the pencil.

In particular, when sharpening a soft-core pencil, such as a cosmetic pencil, it is advantageous for the sharpener to include a “shape” blade in area opposite the insert opening and for the viewing channel to enable viewing of the shape blade and the bottom area of the sharpening blade surrounding the shape blade. Contrary to writing or drawing pencils, with a cosmetic pencil it is desirable to create a rounded pencil tip with a defined round shape. For this purpose, in addition to the sharpening blade (shaving blade) a so-called “shape” blade is used, which penetrates with a curved cutting edge into the pencil guiding channel in the area of the pencil tip, so that during the sharpening process the core mass of the pencil is shaved off at the shape blade and a desired shape of the tip is formed. Thus the core former, also called the “shape” blade, is either embodied as an integral part of the sharpener body or as a separate part that can be connected thereto. Due to the fact that this shape blade is responsible for the actual sharpening of soft-core pencils, such as a cosmetic pencil, the arrangement of the viewing channel is advantageous if it enables the observer to view the shape blade and the bottom of the sharpening blade surrounding the shape blade.

The viewing channel can advantageously extend essentially perpendicular in reference to the longitudinal axis of the cone-shaped sharpening channel. “Essentially perpendicular” in reference to the longitudinal axis of the cone-shaped sharpening channel means in this case that the longitudinal viewing channel extends at an angle ranging from 45° to 125° in reference to the longitudinal axis of the sharpener channel. The angle preferably amounts to 90°±5°.

In particular, when the viewing channel crosses at least sections of the collection container it is advantageous for the viewing channel to be provided with lateral walls, which form a closed channel structure. Using such a closed channel structure minimizes the chance that shavings located in the collection container can reach the viewing channel, which could compromise the view of the user to the bottom of the sharpening blade.

The viewing channel can have a circular, round, rectangular, or polygonal cross-sectional contour. In particular, cross-sectional contours with rounded viewing channels are advantageous because they form at the exterior a surface less susceptible for shavings to engage in the edge regions of the exterior of the viewing channel. In one exemplary embodiment, the viewing channel may also comprise a cross-sectional contour according to a keyhole or the like in order to signal to the user of the sharpener the use of the viewing channel to observe the sharpening blade. Of course, other cross-sectional contours of the viewing channel are also possible, which for example may represent a logo or a number or a letter for advertisement purposes. Further, it is advantageous for the cross-sectional contour of the viewing channel to remain constant over its longitudinal axis.

In another advantageous embodiment the wall-side end of the sharpener channel is enclosed with a transparent window section. Due to the fact that the sharpener gap may lead to shavings from the collection container reaching the environment through said gap it is advantageous for the sharpening channel to be closed by such a transparent window section (e.g., a transparent plastic element). Here, it is useful to fasten the window section to the sharpening channel in a detachable fashion in order to allow, for example, cleaning of the viewing channel by removing shavings located in the viewing channel. The detachable fastening of the window section can be provided via a force-fitting and/or a form-fitting arrangement. For example, the window section is connected to the housing in a latching fashion.

Additionally, the sharpener may be embodied as a dual-sharpener, comprising at least two sharpening blades and allocated thereto, at least sectionally cone-shaped sharpening channels. The housing wall comprises an opening for each sharpening blade and/or a transparent section (window section) enabling the respective bottom of the sharpening blade to be viewed. In general it can be possible to make the viewing channels V-shaped as well, so that starting from the individual exterior entry area (i.e., opening and/or window section) two channels extend to the respective bottoms of the blades so that the user can observe via a single channel the opening section of both respective bottom sections of the blades.

In a particularly advantageous embodiment the opening and/or the housing side comprising the transparent window section are convex and the housing section opposite said opening and/or transparent window section is embodied as a planar support surface. This measure prompts the user to place the sharpener on a placement area such that the window section is aligned upwards and “free” and thus enables the viewing channel to be observed by the user. The user will, therefore, not be tempted to place the sharpener on a convex housing side because this may lead to a tipping of the sharpener.

This is essentially based on the idea to form the exterior contour of the sharpener such that the only plane surface of the housing is the area opposite the viewing channel so that the user will always place the sharpener on said side and thus is given the opportunity to see the bottom of the blade through the viewing channel.

In another advantageous embodiment the window section is embodied as an optic lens so that by an enlarging and/or wide-angle effect the blade section to be observed is enlarged and/or the window section is reduced in reference to the section observed. Further, lighting elements (e.g., LED) may be arranged at or in the sharpener to illuminate the section observed.

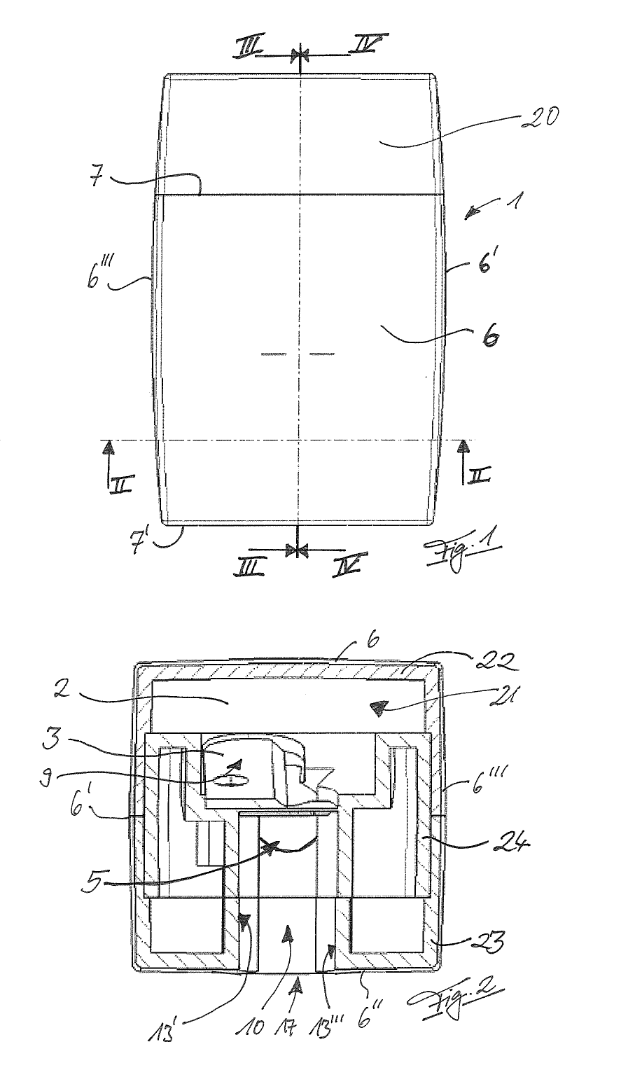

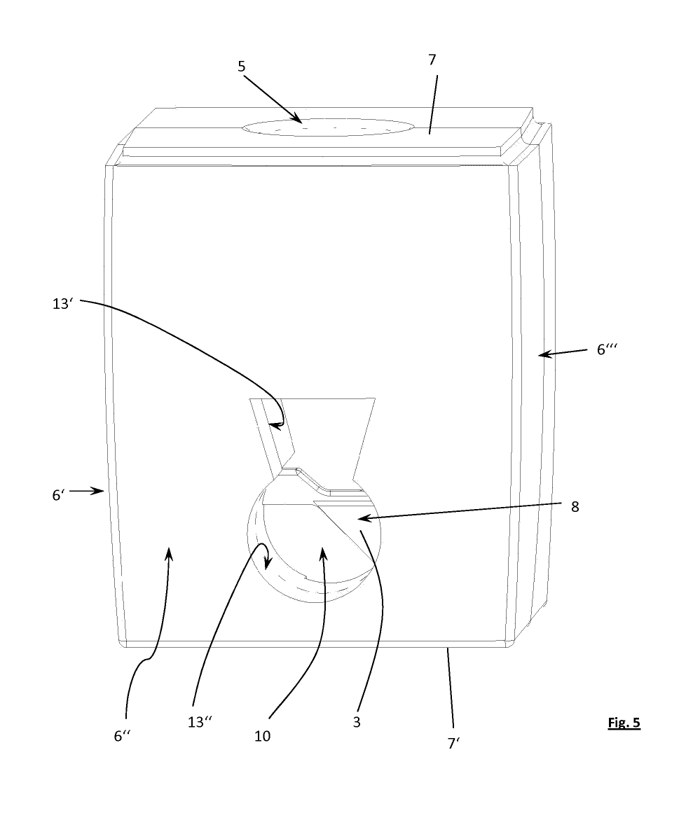

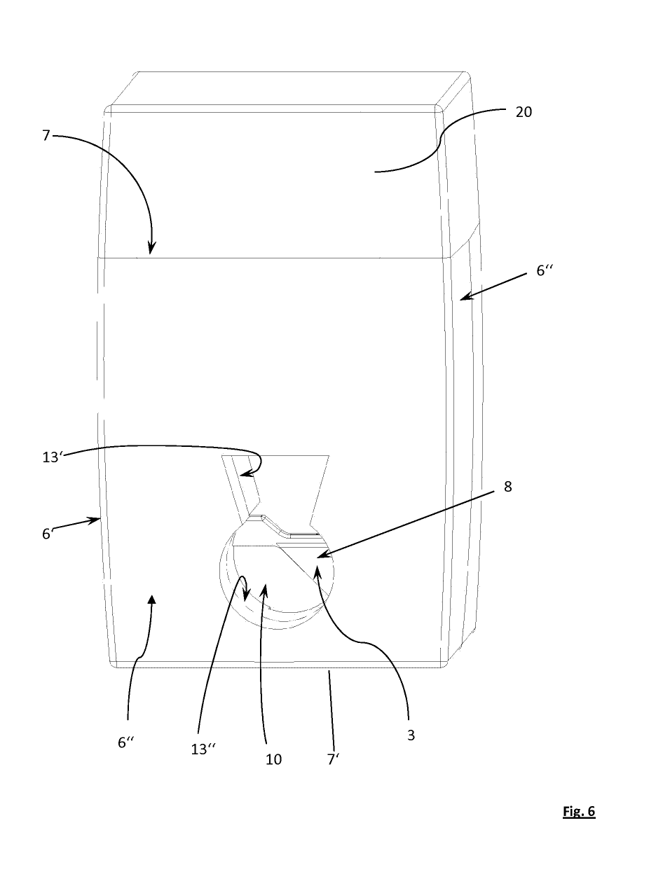

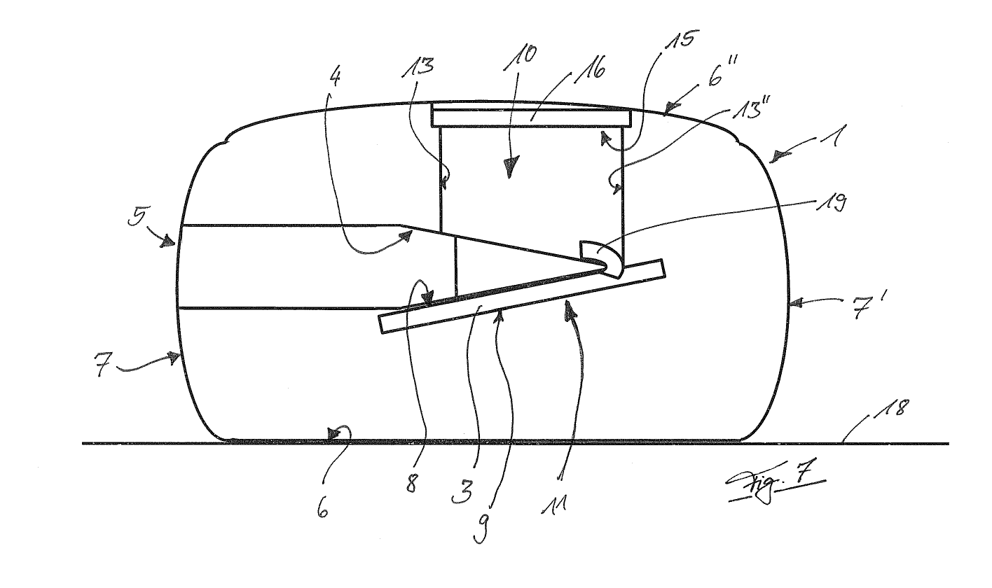

FIGS. 1-6 show a first embodiment of the sharpener according to the invention. It comprises a housing 1, showing a collection container 2, a sharpening blade 3, as well as an adjacent at least partially cone-shaped sharpening channel 4 with an insert opening 5. The housing 1 comprises, in the essentially block-shaped embodiment shown, four longitudinal side walls 6, 6′, 6″, 6′″ as well as an upper and lower end wall 7, 7′, which are made from an opaque or translucent material. The sharpening blade 3 faces with its bottom 8 the sharpening channel 4 so that the top 9 of the sharpening blade 3 faces a shaving removal section 21. The area shall be considered the shaving removal section 21, in which the “shavings” of the pencil to be sharpened are stored immediately after the sharpening process. At a later point in time these “shavings” may also reach other sections of the housing 1.

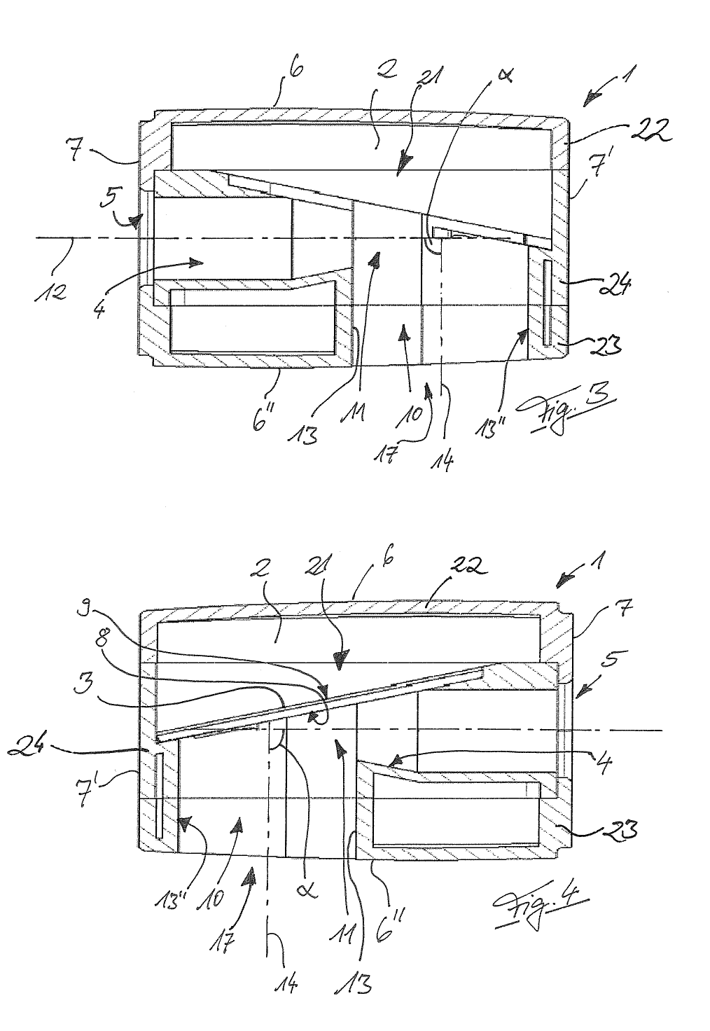

The sharpener comprises a viewing channel 10, which extends from an opening 17 and/or a window section 16 of a wall 6″ of the housing 1 through the sharpening channel 4 to the bottom 8 of the sharpening blade 3. In particular FIGS. 2-6 show the viewing channel 10. Here, the view through the viewing channel 10 to the area 11 opposite the insert opening 5 shows the bottom 8 of the sharpening blade 3.

In the embodiment shown in FIGS. 1-6 the viewing channel 10 is essentially arranged perpendicular in reference to the longitudinal axis 12 of the cone-shaped sharpening channel 4. The angle α formed here between the longitudinal axis 12 of the sharpening channel 4 and the longitudinal axis 14 of the viewing channel 10 can generally range from 45° to 135°.

Further, the viewing channel 10 is provided with lateral walls 13, 13′, 13″, 13′″, which at least sectionally form a closed channel structure. In general, the viewing channel 10 may have a circular, oval, rectangular, or polygonal cross-sectional contour, whereas in the embodiment shown, the viewing channel 10 also includes a circular section which transfers into a trapezoid section. Overall, this geometry may be called a keyhole contour and thus may indicate to the user of the sharpener that a clear view is provided through this viewing channel 10. The cross-sectional contour of the viewing channel 10 is constant over its extension along the longitudinal axis 14 of the viewing channel 10.

In another advantageous embodiment, shown in FIG. 7, the wall-side end 15 of the viewing channel 10 is closed with a transparent window section 16. The window section 16 may be embodied as a transparent plastic element, for example, and is advantageously connected to the housing 1 and/or the housing wall 6″ in a detachable fashion. By the presence of such a window element 16 it is possible that no shavings can reach the environment of the sharpener via the viewing channel 10. In order to remove shavings from the blade 3 and/or the viewing channel 14 it is advantageous to fasten the transparent window element and/or the transparent window section 16 in a detachable fashion to the housing 1, in order to allow access to the viewing channel 10 from the outside by temporarily removing the window section 16.

Another advantageous aspect may be the embodiment of the exterior form of the housing 1. Here, it is advantageous to embody targeted sections of the housing 1 such that they are not placed “stably” on a plane surface, e.g., like an indifferent balance. This means that only a small contact surface (or line or point) exists when placing the housing 1 at these sides onto the placement surface 18. For example, here the housing 1 and/or the housing walls 6′, 6″, 6′″, 7, 7′ are formed convex at these sections, at least at the outside, so that a small contact surface (or line or point) between the housing 1 and the placement surface 18 leads to an easy motion of the sharpener. According to the invention only one housing surface (here, wall 6) is embodied in a planar fashion. In general, the wall 6 may also show different geometries, however the wall 6, when placed upon a planar support surface 18, will hold the sharpener in a stable fashion when being touched and prevent any tipping or “wiggling” of the sharpener. As shown in FIG. 7, the housing 1 shows surfaces arced outwardly at its walls 6′, 6″, 6′″, 7, 7′, with a window section 16 being arranged at the wall 6″. The wall 6 opposite the window section 16 is embodied in a planar fashion so that the sharpener can only be placed “wiggle-free” on a placement surface 18 in this alignment. This way, the user of the sharpener is urged to place the sharpener such that the viewing channel 10 is released to the top and the operator can view through the viewing channel 10 to the bottom 8 of the sharpening blade 3.

As an alternative to the above-mentioned window section 16, essentially adjusted to the diameter of the viewing channel 10, it may also extend over the entire surface of the wall 6″ and enable observation of, among other things, the viewing channel 10. This window section 16 embodied as the entire wall section or at least a large portion of the wall section 6″, may here also be provided with a chasing or a convex arc in order to “prevent” any placement on this surface. Additionally, a wall section 6″ arranged in this fashion may also be fastened at the housing in a detachable fashion.

In FIG. 7 a “shape” blade 19 is further arranged in the area of the sharpening blade 3. This shape blade 19 serves to shape the end section of the core of the pencil to be sharpened. The user of the sharpener may observe through the window section 16 via the viewing channel 10 both the bottom 8 of the sharpening blade 3 as well as the shape blade 19, at least sectionally, during the sharpening process.

It is discernible particularly from FIGS. 2-4 that a cap 20 is used for temporarily closing the insert opening 5 and can be placed upon the wall 7 of the housing 1. The housing 1 comprises three elements 22, 23, 24.

These elements comprise a first housing shell 22, a second housing shell 23, as well as a core element 24, surrounded by the two housing shells at least laterally. The distribution of the sharpener into these three housing elements 22, 23, and 24 allows both an economic production as well as a simple assembly of the sharpener. The first housing shell 22 comprises here the wall 6 as well as sections of the walls 7, 7′, 6′, 6′″. The second housing shell 23 comprises primarily the wall 6″ with the opening of the viewing channel 10 as well as at least sections of the walls 7, 7′, 6′, 6′″. In the embodiment shown the core element 24 forms on the one side a sharpening channel 4, the contact surfaces for the sharpening blade 3, a partial section of the viewing channel 10, as well as parts of the housing wall 7′.

While the present invention has been disclosed with reference to certain embodiments, numerous modifications, alterations and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof. While the invention has been disclosed with reference to certain embodiments, numerous modifications, alterations and changes to the described embodiments are possible without departing from the spirit and scope of the invention, as defined in the appended claims. Accordingly, it is intended that the present invention not be limited to the described embodiments, but that it has the full scope defined by the language of the following claims, and equivalents thereof.

What is claimed is:

1. A sharpener for writing, drawing, and/or cosmetic pencils comprising:
a housing comprising a collection container, a sharpening blade, and an adjacent, at least partially cone-shaped sharpening channel having an insert opening,
wherein walls of the housing comprise at least one of an opaque and a translucent material and the sharpening blade has a bottom facing the sharpening channel and a top facing a shaving removal area, and
wherein the sharpener comprises a viewing channel extending from an opening or a clear section of at least one of said walls of the housing through the sharpening channel towards the bottom of the sharpening blade.

2. The sharpener of claim 1, wherein the viewing channel enables a user to view an area of the bottom of the sharpening blade facing away from the insert opening.

3. The sharpener of claim 1, wherein a form blade is arranged adjacent to the sharpening blade facing away from the insert opening and the viewing channel enables a user to view the form knife and the bottom area of the sharpening blade surrounding the form blade.

4. The sharpener of claim 1, wherein the viewing channel extends essentially perpendicular or at an angle ranging from about 45°-135° in reference to a longitudinal axis of the cone-shaped sharpening channel

5. The sharpener of claim 1, wherein the viewing channel has lateral walls that form a closed channel structure.

6. The sharpener of claim 5, wherein the viewing channel comprises a circular, oval, rectangular, or polygonal cross-sectional contour.

7. The sharpener of claim 5, wherein a cross-sectional shape of the viewing channel is constant over its longitudinal axis.

8. The sharpener of claim 1, wherein a wall-side end of the viewing channel of the sharpening channel is closed by a transparent window section.

9. The sharpener of claim 8, wherein the transparent window section is detachably connected to the housing wall.

10. The sharpener of claim 1, wherein the sharpener comprises at least two sharpening blades and at least two sharpening channels, each of said at least two sharpening channels being at least partially cone-shaped, wherein the at least two sharpening blades each are positioned adjacent to at least one of an opening and a transparent window section of the housing wall with the viewing channel enabling a user to view respective bottom portions of the sharpening blades.

11. The sharpener of claim 10, wherein the transparent window section is detachably connected to the housing wall.

12. The sharpener of claim 10, wherein a portion of the housing comprising the opening or the transparent window section is convex and a portion of the housing opposite the opening or the transparent window section comprises a plane support area.

13. The sharpener of claim 10, wherein a portion of the housing opposite the opening or the transparent window section comprises a plane support area, and a remainder of the housing portions are convex.
